(19) United States
(12) Patent Application Publication
(10) Pub. No.: US 2021/0107738 A1
(43) Pub. Date: Apr. 15, 2021

(54) MATERIAL TRANSFER VEHICLE WITH MODULAR ENGINE ASSEMBLY

(71) Applicant: Roadtec, Inc., Chattanooga, T (US)

(72) Inventor: Matthew Neisen, Soddy Daisy, TN (US)

(73) Assignee: Roadtec, Inc., Chattanooga, TN (US)

(21) Appl. No.: 17/067,029

(22) Filed: Oct. 9, 2020

Related U.S. Application Data
(60) Provisional application No. 62/913,367, filed on Oct. 10, 2019.

(51) Int. Cl. B65G 15/28; E01C 23/00; B60K 15/063; B60K 5/00; F02M 35/10; F02M 31/20; F01P 5/10; F01N 3/08; F15B 21/00

(52) U.S. Cl. CPC B65G 15/28; E01C 23/00; B60K 15/063; B60K 5/00; E01C 2301/04; F02M 31/20; F01P 5/10; F01N 3/08; F15B 21/00; F02M 35/10091

(57) ABSTRACT

A material transfer vehicle includes a frame, a plurality of ground-engaging drive assemblies that define a plane of locomotion, a front end and a rear end. A discharge conveyor is located at the rear end and is adapted to convey asphalt paving material to the receiving hopper of an asphalt paving machine. An engine provides the motive force for driving the ground-engaging drive assemblies and is located on the frame at the rear end of the material transfer vehicle behind the ground-engaging drive assemblies and below the discharge conveyor. In a preferred embodiment of the invention, a fuel tank and a hydraulic fluid tank are located between the ground-engaging drive assemblies.

### CROSS-REFERENCE TO RELATED APPLICATION

This application claims the benefit of U.S. Provisional Patent Application No. 62/913,367, which was filed on Oct. 10, 2019.

### FIELD OF THE INVENTION

This invention relates generally to material transfer vehicles, and more particularly, to a material transfer vehicle having a physical configuration that provides greater machine stability, easier access to the engine and to the fuel and hydraulic tanks, while locating the engine away from the vehicle operator.

### BACKGROUND OF THE INVENTION

Asphalt paving material is comprised of an asphaltic binder and aggregates of various particle sizes, including both coarse and fine aggregate materials. Because the equipment needed to produce asphalt paving material is expensive and the space required extensive, asphalt paving material is typically produced in a production facility that is dedicated to such purpose. Consequently, it is frequently necessary to transport the asphalt paving material from its place of origin to an asphalt paving machine at a remote paving site. The asphalt paving material is usually transported in dump trucks to an asphalt paving machine or to a material transfer vehicle that completes the transfer to the asphalt paving machine.

An asphalt paving machine is a self-propelled vehicle that is driven by a wheeled or tracked drive system. In a common type of paving machine, an asphalt receiving hopper is located at the front end of the machine to receive asphalt paving material, and a slat-type hopper conveyor located below the asphalt receiving hopper transfers the asphalt paving material from the hopper to a distribution assembly comprising a transverse distributing auger that is mounted at the rear of the machine. The asphalt paving material is deposited onto and across the roadway or other surface to be paved by the distributing auger, and a floating screed located behind the distributing auger compacts the asphalt paving material to form an asphalt mat.

Sometimes, asphalt paving material is discharged directly from a delivery truck into the asphalt receiving hopper of the asphalt paving machine. A dump-type delivery truck is unloaded by raising the truck bed and allowing the asphalt paving material to slide down the bed into the receiving hopper. When the truck bed is raised, it should not come into contact with the receiving hopper and should not be carried by or ride on any portion of the paving machine. For smaller-capacity dump trucks, contact with the paver is not often a problem. However, such contact can be a problem when large tractor-semitrailer units are used as delivery vehicles, particularly when the truck bed is extended to its highest point. In addition, if a delivery truck contacts the paver so that a portion of the weight of the delivery truck is carried by the paver as the paving operation is carried out, the screed elevation may be changed, which will affect the smoothness of the finished asphalt mat.

When asphalt paving material is delivered to the paving machine by delivery trucks, it is frequently necessary for a series of delivery trucks to move into contact with the front end of the paving machine to serially discharge their loads into the paving machine's asphalt receiving hopper. This method of delivery requires multiple truck maneuvers that are often difficult to achieve without stopping the paving machine. However, when a paving machine stops and subsequently restarts, its floating screed will produce a dip in the asphalt mat (when the machine stops) and a bump (when it restarts). In addition, because a typical delivery truck carries more asphalt paving material than can be unloaded quickly into the receiving hopper of the asphalt paving machine, it is frequently necessary for the paving machine to push the truck in the paving direction as the truck is unloaded while paving proceeds. This may be difficult to manage when the paving machine is proceeding through intersections or operating on curved sections of the roadway. Furthermore, the ability of the paving machine operator to place a smooth mat on the roadway will be affected by the rate of feed of asphalt paving material to the paving machine. This requires planning for proper scheduling of delivery trucks and coordination with the asphalt production facility. However delays at the production facility or traffic encountered by the delivery trucks can thwart the efforts of the most careful planners. Consequently, because it is desirable to keep the paving machine moving at all times during an asphalt paving operation, and since delivery trucks must be unloaded as they are pushed along in the paving direction, it is frequently necessary to have delivery trucks queue up near the paving machine to ensure that a loaded truck is available to move quickly into unloading position as an unloaded truck is moved out of the way. This may result in heat losses in the asphalt paving material in the waiting trucks, which can affect the quality of the asphalt mat being created by the paving machine.

A delivery truck can also be used to deliver the asphalt paving material to a windrow on the roadway in front of the paver. If the delivery truck is a dump truck, the windrow is usually formed by a spreader box or a windrow blending unit. If a spreader box is used, it will be pulled behind the truck, and the truck bed raised to deposit the asphalt paving material into the box. As the truck moves forward, the asphalt paving material is uniformly metered out of the box onto the roadway. If a windrow blending unit is used, it will typically be attached to a small front-end loader, and the asphalt paving material dumped onto the existing roadway across the width of the truck bed. The windrow blending unit will fold the asphalt paving material into a windrow as the blending unit is pushed forward by the loader. A bottom-unloading truck may also be used to deposit asphalt paving material in the form of a windrow onto the roadway.

When asphalt paving material is deposited on the roadway in the form of a windrow, it may be picked up from the roadway surface by a windrow elevator that is attached to the front of the asphalt paving machine. However, because it is desirable to keep the paving machine moving at all times while the paving machine is being operated, the windrow method of delivery may still require delivery trucks queueing up near the paving machine to insure that a windrow of asphalt paving material is available as soon as it is needed by the paving machine. This may also result in heat losses in the asphalt paving material in the waiting windrows, which can affect the quality of the asphalt mat being created by the paving machine.

For all of the difficulties associated with the timely delivery of asphalt paving material by individual delivery trucks to a paving machine or in the form of windrows, material transfer vehicles have been used in recent years to transport asphalt paving material to an asphalt paving machine. A material transfer vehicle may be used to shuttle asphalt paving material between the delivery trucks and the asphalt paving machine. Another type of material transfer vehicle is equipped with a windrow pick-up head that can pick up a windrow of asphalt paving material that has been dumped on the roadway as the material transfer vehicle is moved into the windrow. These vehicles are adapted to move adjacent to an asphalt paving machine and transfer the asphalt paving material received from the trucks or the windrows into the receiving hopper of the asphalt paving machine. Still another type of material transfer vehicle is adapted to move adjacent to the asphalt paving machine while being tethered to a delivery truck to allow for the transfer of asphalt paving material from a delivery truck to an asphalt paving machine without requiring either the delivery truck or the material transfer vehicle to make direct contact with the asphalt paving machine, thus reducing the time required for delivery truck maneuvers and reducing the risk that the paving machine will have to stop during the paving operation.

Self-propelled material transfer vehicles may include a large-capacity truck-receiving hopper or a window pick-up head, and an inclined loading conveyor extending upwardly from the hopper or pick-up head. A transversely oriented auger in the truck-receiving hopper or windrow pick-up head may be provided to urge asphalt paving material onto the loading conveyor. The asphalt paving material is carried upwardly by the loading conveyor from the truck-receiving hopper or pick-up head and discharged off the elevated output end of the loading conveyor into a chute mounted on the lower end of a discharge conveyor, or into an intermediate surge bin that is sized to hold the entire load of a delivery truck. The discharge of asphalt paving material off the elevated output end of the loading conveyor so that it may fall under the influence of gravity into a chute or surge bin assists in preventing undesirable segregation of the various particulate components of the asphalt paving material by particle size.

Material transfer vehicles of the type that are equipped with a surge bin typically include an auger and a conveyor in the surge bin that are adapted to transfer the asphalt paving material to the discharge conveyor. The auger in the surge bin re-blends the asphalt paving material to eliminate particle size segregation that occurs as the material is transported. It also helps to keep the heat in the asphalt paving material evenly distributed throughout the entire load of material obtained from the delivery truck or windrow.

Discharge conveyors that are mounted on self-propelled material transfer vehicles with and without surge bins are generally pivotable about a substantially vertical axis so that the material transfer vehicle can be positioned adjacent to an asphalt paving machine that is laying an asphalt mat and rapidly discharge asphalt paving material into the hopper of the paving machine as the material transfer vehicle moves with the paving machine along the roadway. Furthermore, these discharge conveyors are configured so that their discharge end may be raised and lowered to position the discharge outlet advantageously with respect to the asphalt receiving hopper of a paving machine. The moveable nature of these discharge conveyors allows for some flexibility in locating the material transfer vehicle adjacent to the asphalt paving machine. Because of its rapid loading and unloading capabilities, a self-propelled material transfer vehicle equipped with a surge bin can rapidly shuttle between delivery trucks or windrows at a pick-up point and an asphalt paving machine that is laying an asphalt mat at a paving site so that there is less likelihood that the paving machine will have to stop paving because of a lack of asphalt paving material.

When a self-propelled material transfer vehicle is used in an asphalt paving process, a delivery truck can be stopped a significant distance away from the paving machine in order to unload its load from a stopped position into the material transfer vehicle or onto the roadway in the form of a windrow. Thus, the delivery truck can unload faster when not unloading directly into the paving machine, and the unloading location may be selected so that there is no danger of the raised dump bed of the truck hitting power lines or tree limbs on the side of the roadway. The use of a material transfer vehicle also reduces the need for delivery trucks to queue up at the paving machine in order to keep it moving, thereby cutting the waiting time of the delivery trucks and thereby reducing truck operating costs.

Self-propelled material transfer vehicles typically weigh 40,000-80,000 lbs. (88,184-176,368 kg). Typically, these vehicles are provided with diesel engines capable of producing up to 305 hp (227 kW) @ 2000 rpm. These engines provide the motive force for driving the ground-engaging drive wheels or track-drive assemblies, as well as power for operating the various hydraulic motors that run the conveyors and augers. Consequently, material transfer vehicles usually include a diesel fuel tank having a capacity of 110-150 gal. (416-568 liters) and a hydraulic fluid tank having a capacity of at least about 80 gallons (303 liters). In conventional material transfer vehicles, the engine is located above the rear wheels (or the track-drive assemblies) or between the front and rear wheels. The conventional engine configuration also locates the engine adjacent to the operator's station or immediately underneath it. In addition, the fuel and hydraulic fluid tanks are usually located entirely above the axes of rotation of the drive wheels or the drive sprockets. Consequently, the center of mass of a conventional material transfer vehicle is located substantially above the axes of rotation of the drive wheels or the drive sprockets. Furthermore, in the conventional configuration, an operator cannot access the engine for maintenance, or to fill the fluid tanks, from ground level.

### Advantages of the Invention

Among the advantages of the invention is that it provides a material transfer vehicle that has a lower center of mass for greater vehicle stability. Another advantage of the invention is that it provides a material transfer vehicle which offers more convenient and safer access to the engine and the fluid tanks. Still another advantage of the invention is that it provides a material transfer vehicle that locates the engine, the primary noise and heat source, farther from the operator than in a conventional vehicle. Yet another advantage of a preferred embodiment of the invention is that it locates the engine, the engine exhaust treatment subassembly, a pump section and the various cooling subassemblies in a modular component that can be mounted on the frame of the vehicle at its rear end, thus simplifying the manufacturing process. Other advantages and features of this invention will become apparent from an examination of the drawings and the ensuing description.

### Notes on Construction

The use of the terms “a”, “an”, “the” and similar terms in the context of describing the invention are to be construed to cover both the singular and the plural, unless otherwise indicated herein or clearly contradicted by context. The terms “comprising”, “having”, “including” and “containing” are to be construed as open-ended terms (i.e., meaning “including, but not limited to,”) unless otherwise noted. The terms “substantially”, “essentially” and other words of degree are relative modifiers intended to indicate permissible variation from the characteristic so modified. The use of such terms in describing a physical or functional characteristic of the invention is not intended to limit such characteristic to the absolute value which the term modifies, but rather to provide an approximation of the value of such physical or functional characteristic.

Terms concerning attachments, coupling and the like, such as “attached”, “connected” and “interconnected”, refer to a relationship wherein structures are secured or attached to one another either directly or indirectly through intervening structures, as well as both moveable and rigid attachments or relationships, unless otherwise specified herein or clearly indicated as having a different relationship by context. The terms “operatively attached” and “operatively connected” describe such an attachment, coupling or connection that allows the pertinent structures to operate as intended by virtue of that relationship.

The use of any and all examples or exemplary language (e.g., “such as” and “preferably”) herein is intended merely to better illuminate the invention and the preferred embodiments thereof, and not to place a limitation on the scope of the invention. Nothing in the specification should be construed as indicating any element as essential to the practice of the invention unless so stated with specificity.

Several terms are specifically defined herein. These terms are to be given their broadest reasonable construction consistent with such definitions, as follows:

The term “asphalt paving material” refers to a bituminous paving mixture that is comprised of asphalt cement and/or an asphalt cement emulsion, crushed stone, recycled asphalt shingles, recycled asphalt pavement materials and/or other aggregate materials of varying particle size, and which is used for paving purposes.

The terms “asphalt paving machine”, “paving machine” and “paver” refer to a finishing machine for applying asphalt paving material to form an asphalt mat on a roadway, parking lot or similar surface. An asphalt paving machine or paver is typically a self-propelled vehicle having a receiving hopper at one end for receiving asphalt paving material, a distributing auger for distributing asphalt paving material across the roadway at the other end, and a floating screed located behind the distributing auger for forming an asphalt mat on the roadway. A conveyor is also provided to move asphalt paving material from the hopper to the distributing auger.

The term “asphalt mat” refers to a layer of asphalt paving material such as is applied by an asphalt paving machine to produce a roadway, parking lot or similar surface.

The term “material transfer vehicle” refers to a self-propelled vehicle that is adapted to receive asphalt paving material from a delivery truck or a windrow and to transfer the asphalt paving material to the receiving hopper of an asphalt paving machine.

The terms “above”, “upper” and similar terms, when used with respect to an engine assembly or component thereof of a material transfer vehicle, or to other components of a material transfer vehicle, refer to a relative location or direction away from the surface on which the vehicle is operated.

The terms “below”, “lower” and similar terms, when used with respect to an engine assembly or component thereof of a material transfer vehicle, or to other components of a material transfer vehicle, refer to a relative location or direction towards the surface on which the vehicle is being operated.

The term “right”, when used herein to describe a relative position or direction on or in connection with a material transfer vehicle, or a component thereof, refers to the right side of the vehicle or component from the perspective of an operator who is driving the material transfer vehicle with the truck-receiving hopper or windrow pick-up head in the leading direction.

The term “left”, when used herein to describe a relative position or direction on or in connection with a material transfer vehicle, or a component thereof, refers to the left side of the vehicle or component from the perspective of an operator who is driving the material transfer vehicle with the truck-receiving hopper or windrow pick-up head in the leading direction.

The terms “front”, “forward” and similar terms, when used with respect to a material transfer vehicle or a component of such a vehicle, refer to a relative location or direction towards the truck-receiving hopper or windrow pick-up head of the vehicle.

The terms “rear”, “behind” and similar terms, when used with respect to a material transfer vehicle or a component of such a vehicle, refer to a relative location or direction towards the discharge conveyor of the vehicle.

The term “plane of locomotion” refers to a two-dimensional plane which is defined by the ground-engaging drive assemblies of a material transfer vehicle. More specifically, the plane of locomotion contains the axes of rotation of the rear drive wheels or the axes of rotation of the drive sprockets of the ground-engaging drive assemblies of a material transfer vehicle, which plane is parallel to the surface on which the vehicle is placed when the vehicle is on a level surface.

### SUMMARY OF THE INVENTION

The invention comprises a material transfer vehicle having a frame, a front end and a rear end, and a plurality of ground-engaging drive assemblies that define a plane of locomotion. The material transfer vehicle also includes a discharge conveyor at its rear end, which discharge conveyor is adapted to convey asphalt paving material to the receiving hopper of an asphalt paving machine. An engine provides the motive force for driving the ground-engaging drive assemblies and is located on the rear end of the frame behind the ground-engaging drive assemblies and below the discharge conveyor.

The preferred embodiment of the invention comprises a material transfer vehicle having an engine assembly comprising the engine, the engine exhaust treatment subassembly, a pump section and various cooling subassemblies, which engine assembly is mounted on an end of the vehicle frame. The configuration and location of this engine assembly of the preferred embodiment permits at least a portion of the engine assembly and at least a portion of the fuel and hydraulic fluid tanks to be located below the plane of locomotion of its ground-engaging drive assemblies. Most preferably, at least about half of the volume of the fuel and hydraulic fluid tanks is located below the plane of locomotion.

In order to facilitate an understanding of the invention, the preferred embodiment of the invention, as well as the best mode known by the inventor for carrying out the invention, is illustrated in the drawings, and a detailed description thereof follows. It is not intended, however, that the invention be limited to the particular embodiment described or to use in connection with the apparatus illustrated herein. Therefore, the scope of the invention contemplated by the inventor includes all equivalents of the subject matter described and claimed herein, as well as various modifications and alternative embodiments such as would ordinarily occur to one skilled in the art to which the invention relates. The inventor expects skilled artisans to employ such variations as seem to them appropriate, including the practice of the invention otherwise than as specifically described herein. In addition, any combination of the elements and components of the invention described herein in any possible variation is encompassed by the invention, unless otherwise indicated herein or clearly excluded by context.

### BRIEF DESCRIPTION OF THE DRAWINGS

The presently preferred embodiment of the invention is illustrated in the accompanying drawings, in which like reference numerals represent like parts throughout, and wherein:

FIG. 1 is a side view of a conventional material transfer vehicle of a first type that may be constructed according to the invention.

FIG. 2 is a perspective view of a conventional material transfer vehicle of a second type that may be constructed according to the invention.

FIG. 3 is a side view of a portion of a material transfer vehicle similar to that shown in FIG. 1 that has been constructed according to the invention.

FIG. 4 is a perspective rear view of a portion of the material transfer vehicle shown in FIG. 3.

FIG. 5 is a rear view of the material transfer vehicle shown in FIGS. 3 and 4.

FIG. 6 is a rear view of the material transfer vehicle shown in FIGS. 3-5, with the engine assembly removed to more clearly show the fuel and hydraulic fluid tanks.

FIG. 7 is a bottom view of the rear end of the material transfer vehicle shown in FIGS. 3-6, showing the fuel tank and hydraulic fluid tank assembly.

FIG. 8 is a top view of the fuel tank and hydraulic fluid tank assembly of the material transfer vehicle shown in FIGS. 3-7.

FIG. 9 is a perspective view of an engine assembly according to a preferred embodiment of the invention, comprising the engine, the engine exhaust treatment subassembly and the various cooling subassemblies.

FIG. 10 is the perspective view shown in FIG. 9, with the top and side of the engine assembly cover removed.

### DESCRIPTION OF THE PREFERRED EMBODIMENTS OF THE INVENTION

This description of the preferred embodiments of the invention is intended to be read in connection with the accompanying drawings, which are to be considered part of the entire written description of this invention. The drawing figures are not necessarily to scale, and certain features of the invention may be shown exaggerated in scale or in somewhat schematic form in the interest of clarity and conciseness.

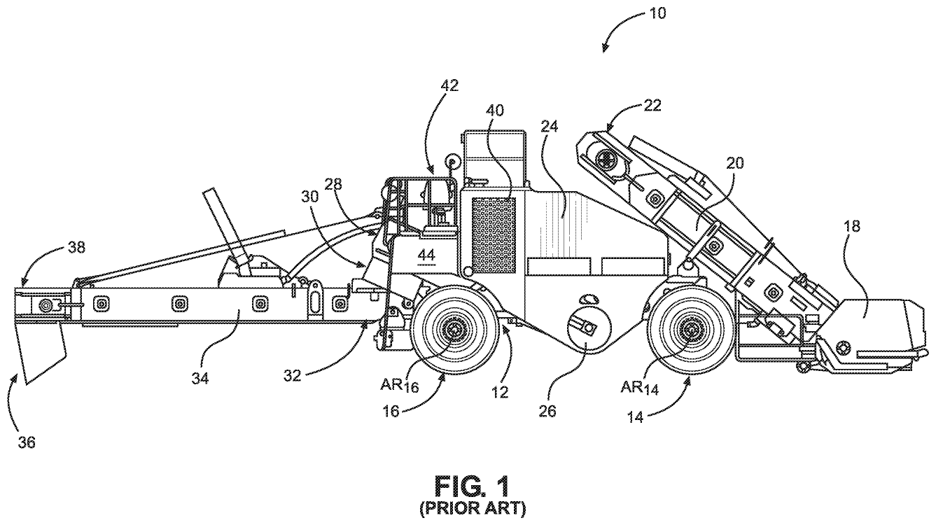

As shown in FIG. 1, a conventional self-propelled material transfer vehicle 10 includes a frame 12 that is supported on the roadway surface by front and rear ground-engaging drive assemblies including right front drive wheel 14 (which rotates about axis of rotation AR₁₄, which is perpendicular to the page on which FIG. 1 is displayed) and right rear drive wheel 16 (which rotates about axis of rotation AR₁₆, which is perpendicular to the page on which FIG. 1 is displayed). Material transfer vehicle 10 also includes a left front drive wheel (not shown but substantially similar to right front drive wheel 14) and a left rear drive wheel (not shown but substantially similar to right rear drive wheel 16). Each of the drive wheels is driven by a hydraulic motor (not shown) that is supplied with fluid under pressure by one or more hydraulic pumps (also not shown). In the alternative, the frame of the vehicle may be supported on the roadway surface by ground-engaging drive assemblies comprising left side track-drive assembly (not shown) having a left drive sprocket, and right side track-drive assembly (also not shown) having a right drive sprocket, as is known to those having ordinary skill in the art to which the invention relates.

Vehicle 10 includes receiving hopper 18 for receiving asphalt paving material from a delivery truck (not shown), although it could be equipped with a windrow pick-up head instead. An auger (not shown) is mounted in receiving hopper 18 and is adapted to assist in conveying asphalt paving material from receiving hopper 18 into loading conveyor 20, which in turn conveys the asphalt paving material off of its output end 22 and into surge bin 24. The surge bin includes transverse auger 26 that is employed to mix the asphalt paving material in the surge bin in order to minimize segregation or separation of the aggregate portion of the asphalt paving material by size. Surge conveyor 28 is adapted to convey asphalt paving material upwardly out of the surge bin so that it may fall through chute 30 and onto input end 32 of discharge conveyor 34.

Discharge conveyor 34 is mounted for vertical pivotal movement about a substantially horizontal pivot axis at its input end that is perpendicular to the page of FIG. 1, as raised and lowered by a linear actuator (not shown). Discharge conveyor 34 is also adapted for side-to-side movement about an essentially vertical pivot axis by operation of one or more additional actuators (also not shown). Asphalt paving material that falls through chute 30 onto discharge conveyor 34 is carried upwardly by the discharge conveyor and discharged through chute 36 at conveyor output end 38 into an asphalt receiving hopper of an asphalt paving machine (not shown).

Hydraulic drive systems including hydraulic pumps and hydraulic motors are provided to drive the various augers and conveyors. An engine (not shown, but located within engine compartment 40 adjacent to operator's station 42) provides the motive force for the hydraulic pumps that drive the hydraulic motors for the drive wheels, the augers and the various conveyors and other components of the vehicle. Fuel tank 44 is located below the operator's station and entirely above the plane of locomotion of material transfer vehicle 10. A hydraulic fluid tank (not shown) is located adjacent to fuel tank 44 on the opposite side of vehicle 10 below operator's station 42 and entirely above the plane of locomotion.

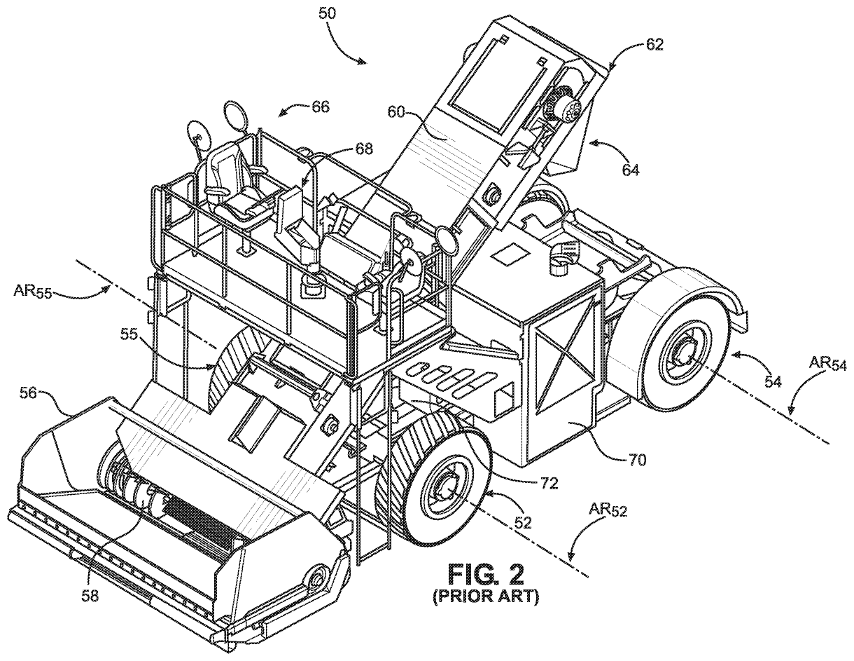

FIG. 2 illustrates an alternative conventional material transfer vehicle 50 which includes a frame that is supported on the roadway surface by front and rear ground-engaging drive assemblies comprising left front drive wheel 52 (which rotates about axis of rotation AR₅₂) and left rear drive wheel 54 (which rotates about axis of rotation AR₅₄). Material transfer vehicle 50 also includes right front drive wheel 55 (which rotates about axis or rotation AR₅₅) and a right rear drive wheel (not shown but substantially similar to left rear drive wheel 54). Each of the drive wheels is driven by a hydraulic motor (not shown) that is supplied with fluid under pressure by one or more hydraulic pumps (also not shown). In the alternative, the frame of the vehicle may be supported on the roadway surface by ground-engaging drive assemblies comprising left side track-drive assembly (not shown) having a left drive sprocket, and right side track-drive assembly (also not shown) having a right drive sprocket.

Vehicle 50 includes receiving hopper 56 for receiving asphalt paving material from a delivery truck (not shown). Auger 58 in receiving hopper 56 is adapted to urge asphalt paving material into loading conveyor 60, which is operatively attached to the receiving hopper. Loading conveyor 60 is adapted to convey asphalt paving material from receiving hopper 56 upwardly to its output end 62, from which it will fall through chute 64 onto the lower input end of a discharge conveyor (not shown, but substantially similar to discharge conveyor 34).

Material transfer vehicle 50 also includes operator's station 66 from which all operating functions of the vehicle may be controlled via control panel 68. Material transfer vehicle 50 includes various hydraulic pumps and hydraulic motors, which are provided to drive the various augers and conveyors. An engine (not shown, but located in engine compartment 70) provides the motive force for the hydraulic pumps that drive the hydraulic motors for the drive wheels, the augers and conveyors and other components of the vehicle. A hydraulic fluid tank 72 is located adjacent to engine compartment 70 below loading conveyor 60 and above the plane of locomotion of material transfer vehicle 50. A fuel tank (not shown) is located adjacent to hydraulic fluid tank 72 on the opposite side of engine compartment 70 below loading conveyor 60 and above the plane of locomotion.

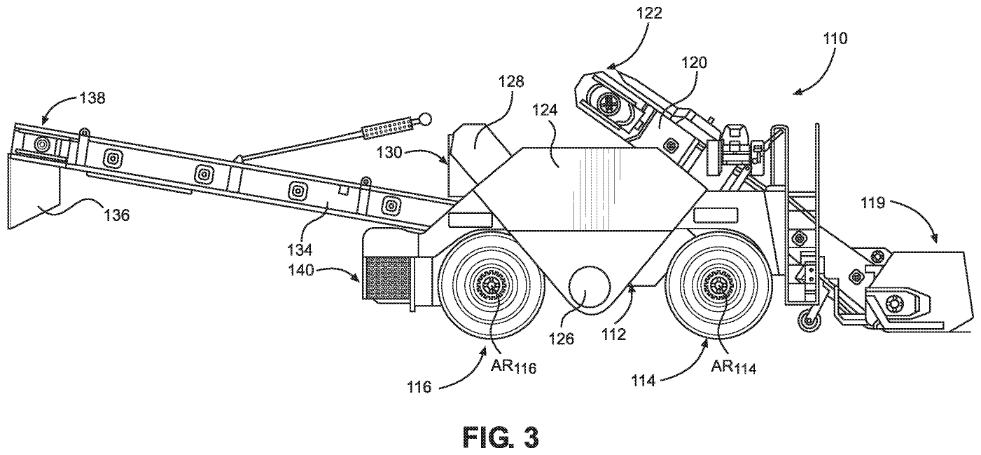

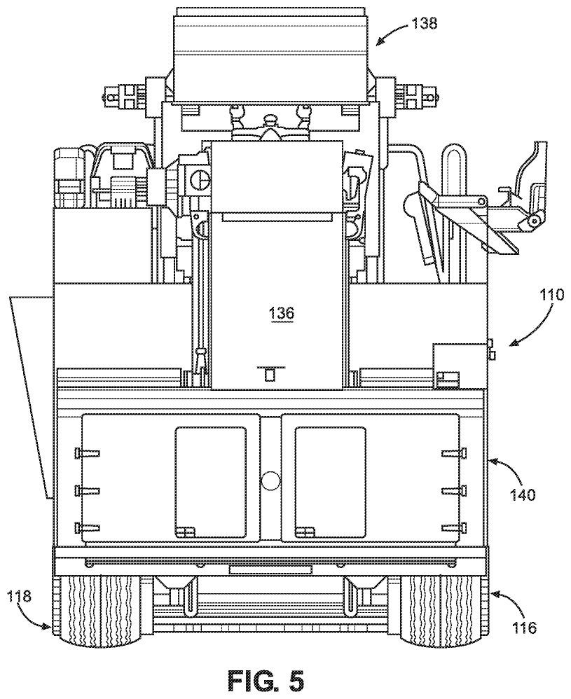

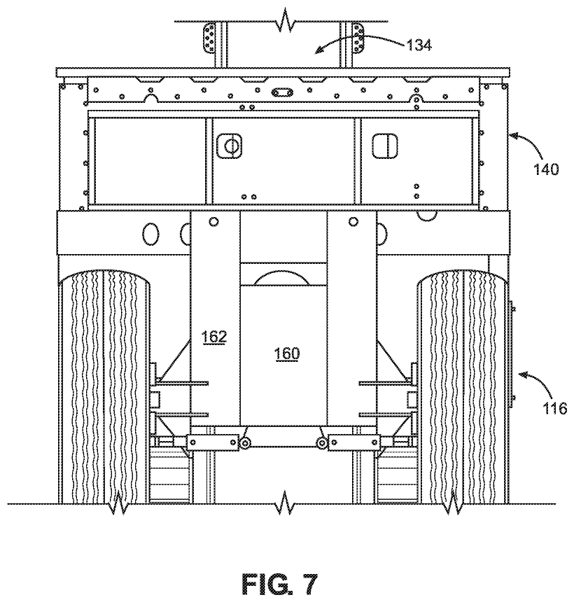

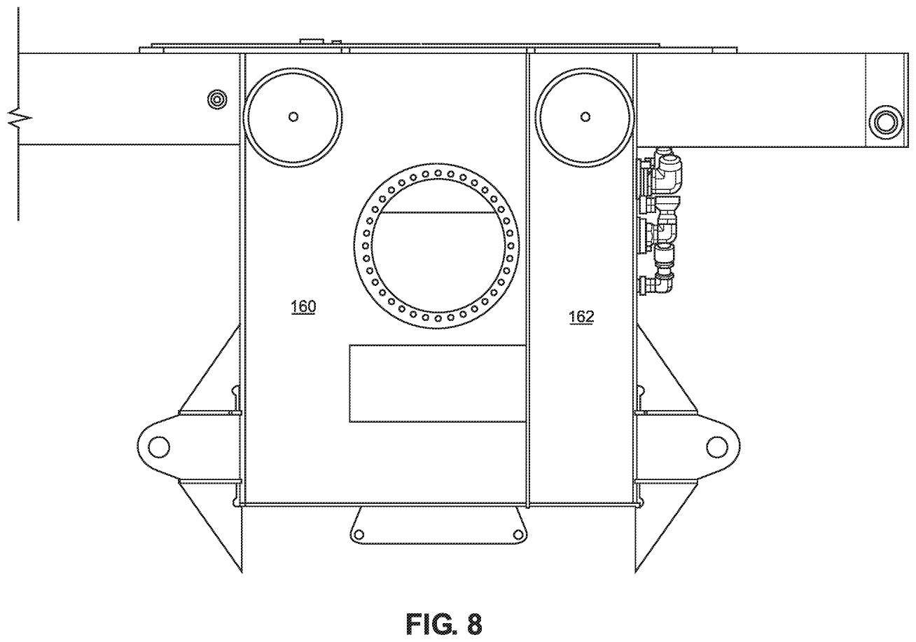

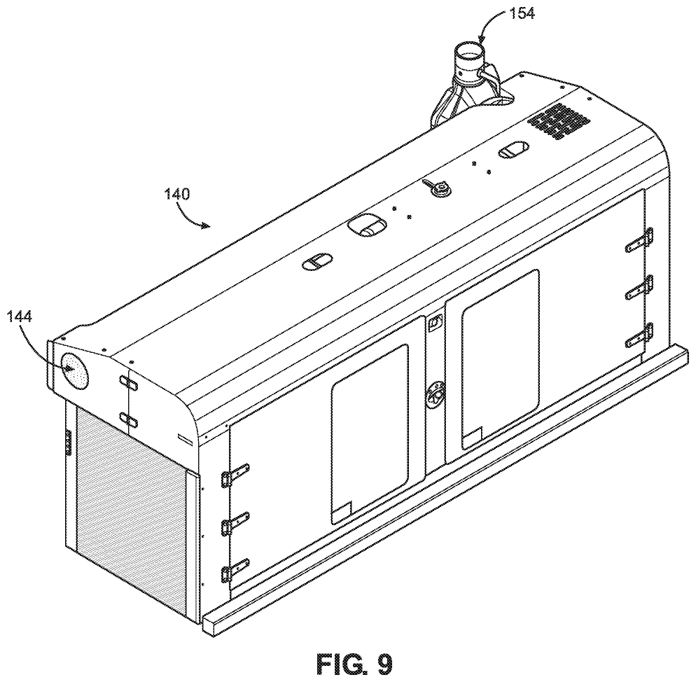

FIGS. 3-10 illustrate a preferred embodiment of the invention. As shown therein, material transfer vehicle 110 includes a frame 112 that is supported on the roadway surface by front and rear ground-engaging drive assemblies comprising right front drive wheel 114 (which rotates about axis of rotation AR₁₁₄) and right rear drive wheel 116 (which rotates about axis of rotation AR₁₁₆). Material transfer vehicle 110 also includes a left front drive wheel (not shown but substantially similar to right front drive wheel 114) and left rear drive wheel 118 (which rotates about axis of rotation AR₁₁₈). Each of the drive wheels is driven by one or more conventional hydraulic motors (not shown) that are supplied with fluid under pressure by one or more conventional hydraulic pumps (also not shown). In the alternative, the frame of the vehicle may be supported on the roadway surface by ground-engaging drive assemblies comprising left and right side track-drive assemblies (not shown).

Vehicle 110 includes a receiving hopper (not shown, but substantially similar to receiving hopper 18 and receiving hopper 56) for receiving asphalt paving material from a delivery truck (not shown), although it could alternatively be equipped with a windrow pick-up head. An auger (not shown) is mounted in the receiving hopper and is adapted to assist in conveying asphalt paving material from the receiving hopper into loading conveyor 120, which in turn conveys the asphalt paving material off of its output end 122 and into surge bin 124. The surge bin includes transverse auger 126 that is employed to mix the asphalt paving material in the surge bin in order to minimize segregation or separation of the aggregate portion of the asphalt paving material by size. Surge conveyor 128 is adapted to convey asphalt paving material upwardly out of the surge bin so that it may fall through chute 130 and onto the input end of discharge conveyor 134.

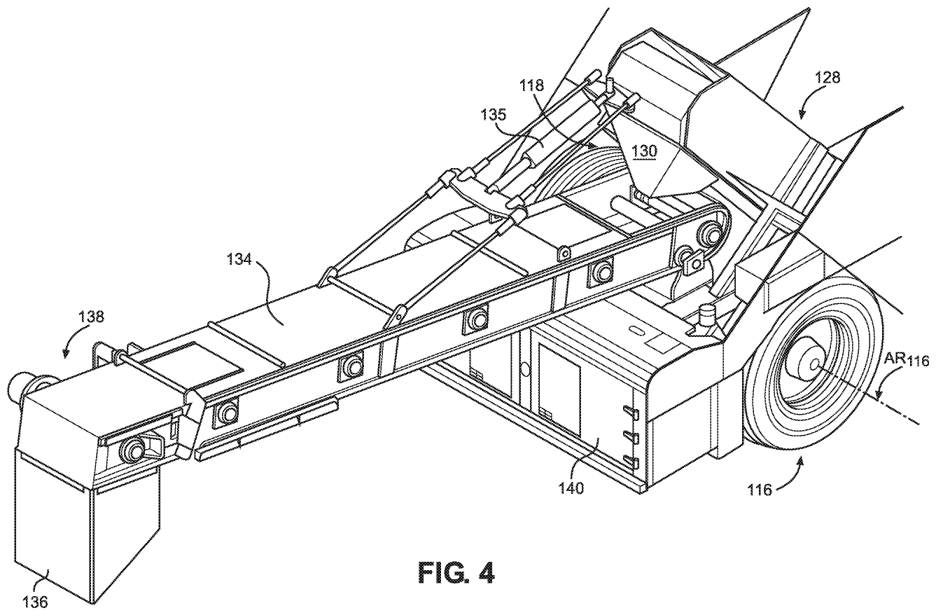

Discharge conveyor 134 is mounted for vertical pivotal movement about a substantially horizontal pivot axis at its input end that is perpendicular to the plane of the page of FIG. 3, as raised and lowered by linear actuator 135 (shown in FIG. 4). Discharge conveyor 134 is also adapted for side-to-side movement about a substantially vertical pivot axis by operation of one or more additional actuators (also not shown). Asphalt paving material that falls through chute 130 onto discharge conveyor 134 is carried upwardly by the discharge conveyor and discharged through chute 136 at conveyor output end 138 into an asphalt receiving hopper of an asphalt paving machine (not shown). Hydraulic drive systems including conventional hydraulic pumps and hydraulic motors are provided to drive the various augers and conveyors.

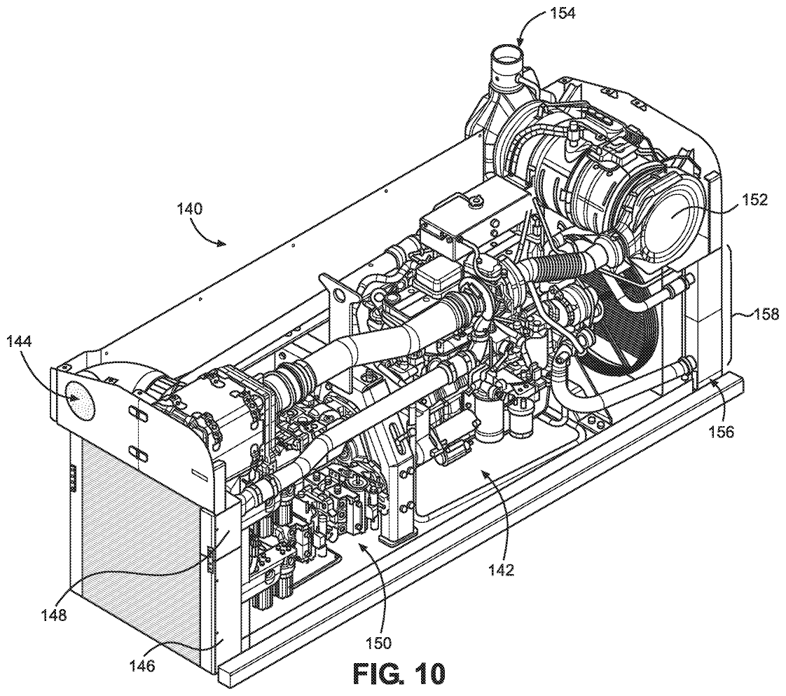

In the preferred embodiment of the invention illustrated in the drawings (especially FIG. 10), modular engine assembly 140 includes engine 142, combustion air intake 144, hydraulic oil cooler 146, charge air cooler 148, pump section 150 (comprising hydraulic, fuel and coolant pumps), engine exhaust treatment subassembly 152, exhaust outlet 154, fuel cooler 156 and radiator 158. Engine 142 provides the motive force for driving the ground-engaging drive assemblies. More specifically, engine 142 provides the motive force for the hydraulic pumps that drive the hydraulic motors for the drive wheels, the augers and the various conveyors and other components of the vehicle.

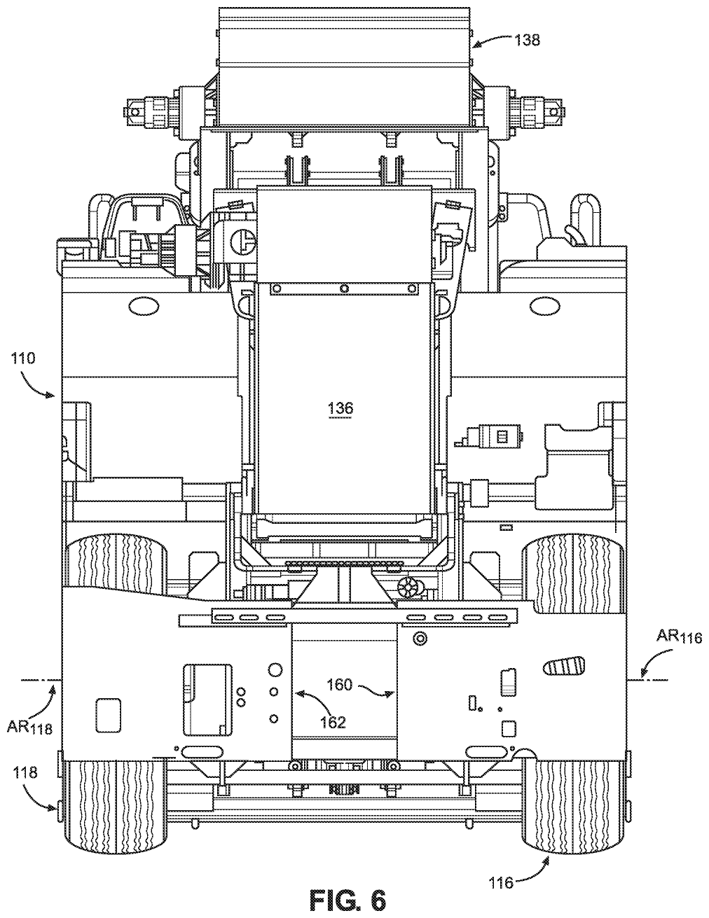

As shown in FIGS. 6-8, the preferred embodiment of the invention locates fuel tank 160 and hydraulic fluid tank 162 between the rear drive wheels. Fuel tank 160 has a fuel tank volume, and at least a portion of the fuel tank volume is located below the plane of locomotion of vehicle 110. Similarly, hydraulic fluid tank 162 has a hydraulic fluid tank volume and at least a portion of the hydraulic fluid tank volume is located below the plane of locomotion of vehicle 110. Most preferably, at least about one-half of the volume of fuel tank 160 and at least about one-half of the volume of hydraulic fluid tank 162 are located below the plane of locomotion of vehicle 110. In addition, modular engine assembly 140 is located adjacent to the fluid tanks and below discharge conveyor 134, as shown in FIGS. 3-6. At least a portion of the modular engine assembly 140 (including engine 142) is also located below the plane of locomotion of vehicle 110.

The invention thus provides a material transfer vehicle, such as vehicle 110, which has a lower center of mass for greater machine stability. The location of engine assembly 140 on the rear end of the frame beneath discharge conveyor 134, and the relocation of the fluid tanks between the rear drive wheels offers more convenient and safer access to the engine and the fluid tanks. It also locates engine 142, the primary noise and heat source, farther from the operator's station than in a conventional vehicle. Furthermore, engine assembly 140 is provided as a modular component or machine sub-assembly that is mounted on an end of the frame of the material transfer vehicle, thus simplifying the manufacturing process.

Although this description contains many specifics, these should not be construed as limiting the scope of the invention but as merely providing illustrations of the presently preferred embodiment thereof, as well as the best mode contemplated by the inventor of carrying out the invention. The invention, as described and claimed herein, is susceptible to various modifications and adaptations, as would be understood by those having ordinary skill in the art to which the invention relates.

What is claimed is:

1. A material transfer vehicle comprising:
(a) a frame;
(b) a plurality of ground-engaging drive assemblies that define a plane of locomotion;
(c) a front end;
(d) a rear end;
(e) a discharge conveyor at the rear end, said discharge conveyor being adapted to convey asphalt paving material to the receiving hopper of an asphalt paving machine;
(f) an engine that provides the motive force for driving the ground-engaging drive assemblies, said engine being located on the frame at the rear end of the material transfer vehicle behind the ground-engaging drive assemblies and below the discharge conveyor.

2. The material transfer vehicle of claim 1, which includes a fuel tank that is located between the ground-engaging drive assemblies.

3. The material transfer vehicle of claim 2 wherein:
(a) the fuel tank has a fuel tank volume;
(b) at least a portion of the fuel tank volume is located below the plane of locomotion.

4. The material transfer vehicle of claim 3 wherein at least about half of the fuel tank volume is located below the plane of locomotion.

5. The material transfer vehicle of claim 1, which includes a hydraulic fluid tank that is located between the ground-engaging drive assemblies.

6. The material transfer vehicle of claim 5 wherein:
(a) the hydraulic fluid tank has a hydraulic fluid tank volume;
(b at least a portion of the hydraulic fluid tank volume is located below the plane of locomotion.

7. The material transfer vehicle of claim 6 wherein at least about half of the hydraulic fluid tank volume is located below the plane of locomotion.

8. The material transfer vehicle of claim 1 which includes:
(a) a fuel tank that is located between the ground-engaging drive assemblies;
(b) a hydraulic fluid tank that is located adjacent the fuel tank and between the ground-engaging drive assemblies.

9. The material transfer vehicle of claim 1 wherein the engine is a part of a modular engine assembly.

10. The material transfer vehicle of claim 9:
(a) which includes a fuel tank that is located between the ground-engaging drive assemblies;
(b) which includes a hydraulic fluid tank that is located adjacent the fuel tank and between the ground-engaging drive assemblies;
(c) wherein the modular engine assembly is mounted to the frame adjacent to the fuel tank and the hydraulic fluid tank.

11. The material transfer vehicle of claim 9 wherein the modular engine assembly includes, in addition to the engine, a combustion air intake, a hydraulic oil cooler, a charge air cooler, a pump section comprising hydraulic, fuel and coolant pumps, an engine exhaust treatment subassembly, an exhaust outlet, a fuel cooler and a radiator.

12. A material transfer vehicle comprising:
(a) a frame;
(b) a plurality of ground-engaging drive wheels including a left rear drive wheel having a left rear axis of rotation and a right rear drive wheel having a right rear axis of rotation;
(c) a front end;
(d) a rear end;
(e) a discharge conveyor at the rear end, said discharge conveyor being adapted to convey asphalt paving material to the receiving hopper of an asphalt paving machine;
(f) an engine that provides the motive force for driving the ground-engaging drive wheels, said engine being located on the frame at the rear end of the material transfer vehicle behind the left rear drive wheel and the right rear drive wheel and below the discharge conveyor;
(g) a fuel tank that is located between the left rear drive wheel and the right rear drive wheel;
(h) a hydraulic fluid tank that is located adjacent to the fuel tank, between the left rear drive wheel and the right rear drive wheel.

13. The material transfer vehicle of claim 12 wherein:
(a) the hydraulic fluid tank has a hydraulic fluid tank volume;
(b) a portion of the hydraulic fluid tank volume is located below the axes of rotation of the left rear drive wheel and the right rear drive wheel;
(c) the fuel tank has a fuel tank volume;
(d) a portion of the fuel tank volume is located below the axes of rotation of the left rear drive wheel and the right rear drive wheel.

14. The material transfer vehicle of claim 12 wherein the engine is a part of a modular engine assembly.

15. The material transfer vehicle of claim 14 wherein the modular engine assembly is mounted to the frame adjacent to the fuel tank and the hydraulic fluid tank.

16. The material transfer vehicle of claim 14 wherein the modular engine assembly includes, in addition to the engine, a combustion air intake, a hydraulic oil cooler, a charge air cooler, a pump section comprising hydraulic, fuel and coolant pumps, an engine exhaust treatment subassembly, an exhaust outlet, a fuel cooler and a radiator.
